(19) United States
(12) Patent Application Publication
(10) Pub. No.: US 2005/0188366 A1
(43) Pub. Date: Aug. 25, 2005

(54) Firmware upgrade method

(75) Inventor: Dyson Chang, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: VIA Technologies Inc.

(21) Appl. No.: 11/046,606

(22) Filed: Jan. 28, 2005

(30) Foreign Application Priority Data
Feb. 25, 2004 (TW) 93104743

(51) Int. Cl. G06F 9/44

(52) U.S. Cl. 717/168

(57) ABSTRACT

A method for upgrading firmware, and in particular, a compact disc device which upgrades firmware by a memory care instead of a compact disc, and a method of the upgrading procedure. Taking the advantage of a memory card's characteristic property rewritability and portability, one can avoid the troublesome CD-R burning procedure before upgrading the firmware, reduce waste of resources and time. Besides, a status further can be stored into the memory card for further debug, to execute a recovery once any error occurred during the firmware upgrading.

### BACKGROUND

The present invention relates to firmware upgrade, and more particularly to a method for upgrade firmware via memory card but not disc.

Firmware is a hardware control program. Firmware is widely used in computers, and is typically stored in a read only memory (ROM). Therefore firmware can also be regarded as hardware comprising programs. Instead of providing functionality by coring wires into circuits, the same functions can be performed through firmware and a processor. In general a firmware upgrade is more flexible and cost efficient than a hardware upgrade.

Currently various technical propositions exist for improving the firmware upgrade process. The goal being a convenient, automatic upgrade process accomplished without demounting or halting the system. Devices with simple functionality are, however, not easily upgradable due to lack of an appropriate interface. For example, a DVD-ROM drive 103 shown in FIG. 1, comprising a firmware manager 104 and memory 105, in which the firmware manager 104 is a traditional function block for processing a firmware upgrade, and the memory 105 can be flash ROM or CMOS, for storing the firmware code. A CD 101 comprising new firmware 102 must be provided to upgrade the DVD-ROM drive 103, and a procedure comprising the following steps is required. The system must be booted, and after initialization, the firmware CD 101 must be analyzed to ensure that the firmware 102 is valid. Corresponding information is then displayed, and upgrade confirmation is received. The firmware 102 is then written to the memory 105 through an input path 106.

The firmware manager 104 is triggered by pressing a key, initializing the upgrade procedure. In another case, the upgrade procedure can be initialized automatically when a firmware CD 101 is detected. After initialization, the firmware 102 is checked for data integrity and version validity by the firmware manager 104. When all conditions are met and the upgrade confirmation is acknowledged, the firmware 102 is written to the memory 105 through an input path 106.

A compact disc, however, is a read only medium requiring specific additional equipment to store data. Therefore, during upgrading, it is hard to decide whether upgrade is complete if any accident is happened. Besides, the quota of compact disc is significantly larger than the required quota of most firmware that used by a device to control the operation of the device, and it is waste to use a disc only for upgrading firmware. Further, because both the burning of a disc and the delivery of disc burned firmware consume some resources and time, the firmware can not be upgraded as sooner and as effective as possible.

### SUMMARY

The present invention provides an efficient firmware upgrade method. The method comprises the following steps. A memory card comprising a first firmware file is provided. Thereafter, a DVD-ROM drive comprising memory for storing firmware is provided. The first firmware file is then written to the memory of the DVD-ROM drive.

The first firmware file comprises integrity information which comprises version code, check sum code, and length code. The version code is used for validating the firmware version. The check sum code is implemented to ensure data integrity, and the length code records firmware file length.

The firmware upgrade method further comprises the following steps. A second firmware file in the memory is copied to the memory card before the first firmware file being written to the memory. Integrity of the first firmware file in the memory is checked after the file being written to memory. Status information is written to a log in the memory card, and when the log indicates an error, the second firmware file is copied from the memory card and stored in the DVD-ROM memory.

The present invention also provides a device controlled by firmware. The device comprises a card reader, a memory and a firmware manager. The card reader reads a memory card to obtain a first firmware file. The memory stores a firmware file which the device executes, and the firmware manager processes a firmware upgrade by writing the first firmware file to the memory.

The firmware manager also executes the following steps: storing a copy of a second firmware file from the memory in the memory card before the first firmware file is written to the memory, checking integrity thereof in the memory after the first firmware file is written to the memory, and writing status information to a log in the memory card. When the log indicates an error, the firmware manager reverses the procedure by copying the second firmware file from the memory card and storing it in the DVD-ROM memory.

The present invention also provides a method of direct firmware upgrade. The method comprises the following steps. First, a memory card is attached to a device requiring firmware upgrade, wherein the memory card stores at least one firmware file. Thereafter, the firmware file in the memory card is processed directly to control the device.

If the memory card comprises more than one firmware file, each of a different version, it is possibly only one firmware file will be chosen to control the apparatus. Further, integrity of the firmware file could be checked by the firmware manager before execution thereof.

### BRIEF DESCRIPTION OF THE DRAWINGS

The following detailed description, given by way of example and not intended to limit the invention solely to the embodiments described herein, will best be understood in conjunction with the accompanying drawings, wherein:

FIG. 1 is a block diagram of a conventional compact disc drive.

FIG. 2 is a block diagram of a compact disc drive according to the present invention.

FIG. 3 shows the data structure of a firmware file.

### DETAILED DESCRIPTION

A detailed description of the present invention is provided in the following.

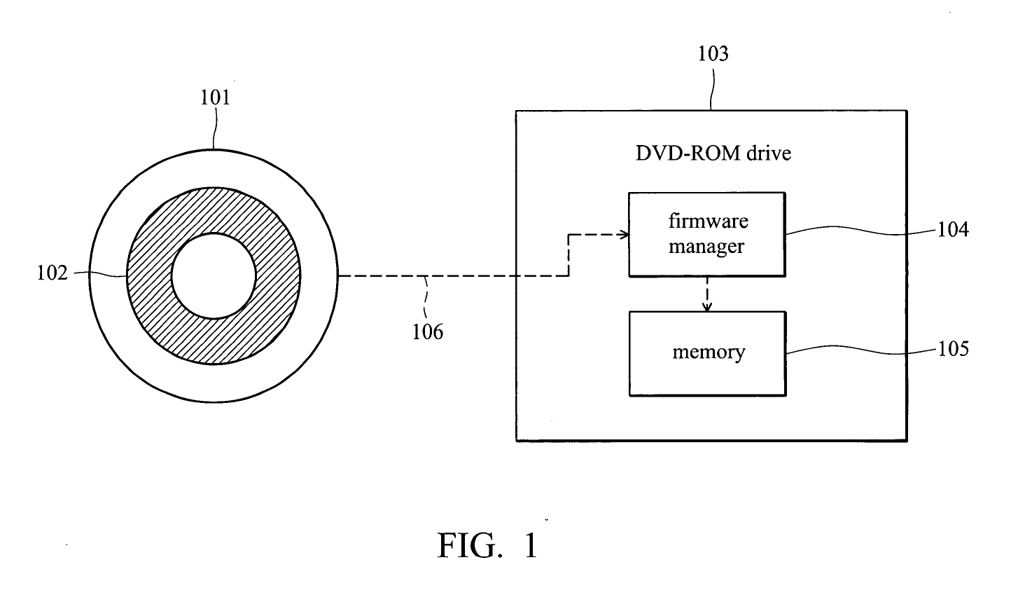

As shown above, FIG. 1 is a block diagram of a conventional DVD-ROM drive. The compact disc 101, however, is read only medium requiring specific additional equipment to store data, and is used only once for the upgrade procedure. Production of the compact disc 101 may be considered wasteful, however, and does not provide a method for instant firmware upgrade. Additionally, the capacity of compact disc 101 is far greater than required by the firmware file 102.

The present invention provides a better solution.

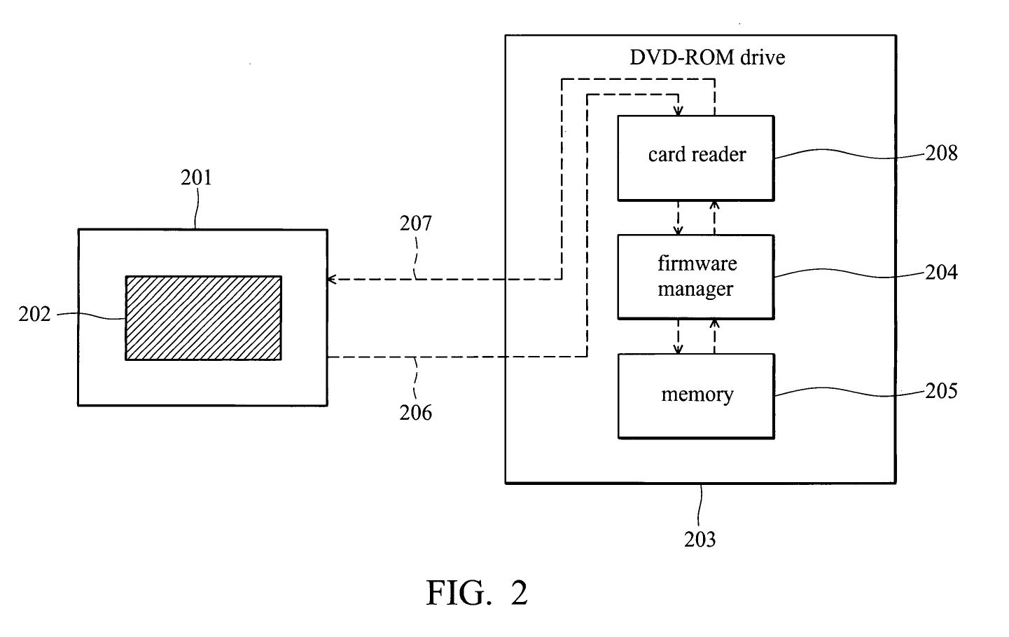

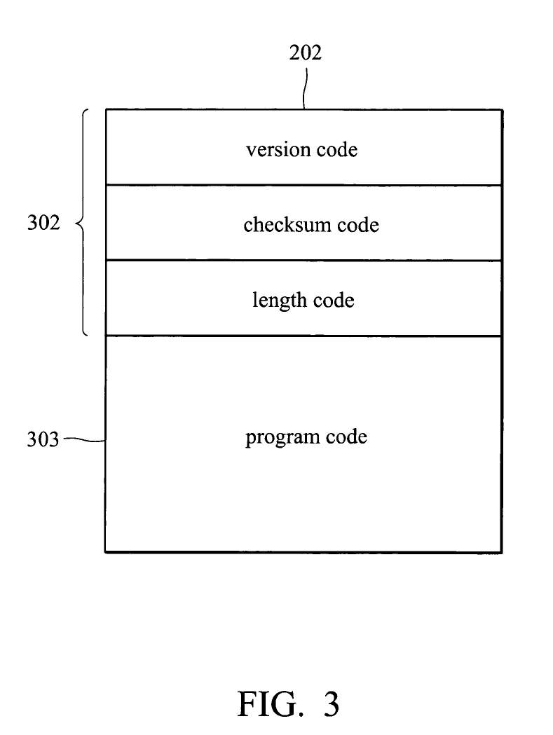

As shown in FIG. 2, a DVD-ROM drive 203 comprises a firmware manager 204, memory 205 and a card reader 205. The firmware manager 204 is the main function block of the present invention for processing firmware upgrade steps. The memory 205 stores a firmware file 202 for controlling DVD-ROM drive 203. Additionally, the card reader 208 reads firmware file 202 from a memory card 201. The firmware file 202 of the DVD-ROM drive 203 is processed by a central processing unit or chipset. The present invention, however, is not limited to the DVD-ROM drive; instead, it should be limited to features presented in FIG. 2 and FIG. 3.

In a preferred embodiment, an old firmware file is stored in the memory 205 of DVD-ROM drive 203, and a new firmware file 202 is stored in a memory card 201.

The memory card 201 is attached to card reader 208 disposed in the DVD-ROM drive 203, and the firmware manager 204 is initialized by pressing a key or is automatically detected. After initialization, a backup is created by copying the old firmware file from the memory 205 to the memory card 201 via an output path 207. Thereafter, the new firmware file 202 is read, validated, and the version is confirmed by the firmware manager 204. When all conditions are met, the new firmware file 202 is written to the memory 205 through an input path 206, overwriting the old firmware file, and the upgrade procedure is complete.

In a preferred embodiment, after firmware file 202 being written into the memory 205, the firmware manager 204 checks integrity of the written firmware via integrity information 302, to ensure the DVD-ROM drive 203 will operate normally, and a log is then stored in the memory card 201. If the log indicates a firmware writing error, two options are provided for decision making. One option is to rewrite the firmware file 202 to the memory 205, and the other option is to recover the old firmware. The backup of the old firmware file previously created in the memory card 201, can be written to the memory 205 again, such that the DVD-ROM drive 203 can be recovered to restore the previous functionality.

The present invention upgrades firmware through a data rewritable memory card instead of a read-only compact disc, thus reducing waste of medium resource, and providing advanced upgrade features such as firmware backup and real-time debugging.

FIG. 3 shows the data structure of the firmware file 202, in which integrity header 302 comprises version, check sum, and length data implemented in a predetermined format. The firmware file 202 also comprises a block embedding binary program code 303 to control the DVD-ROM drive 203. By checking the integrity information 302, failures due to firmware file integrity problems can be avoided.

In some embodiments, only a portion of the firmware file 202, (shown as binary program code 303) is executable. Additional file headers 302 are packed along with the binary program code 303 for integrity checking or validation during transfer between the memory card 201 and the DVD-ROM drive 203. In some cases the firmware file 202 can be divided into several files, each having a file header and a block header, therein comprising integrity information 302 comprising version code, check sum code and length code.

In another case, as shown in FIG. 2, a DVD-ROM drive 203, comprising a card reader 208, is provided. When the memory card 201 is attached to the card reader 208, the DVD-ROM drive 203 can be controlled in an alternative mode, whereby the firmware file 202 is executed directly through the memory card 201, omitting the steps of copying the firmware file 202 to the memory 205. This method provides more flexible and convenient version control of firmware file 202, overcoming bottlenecks presented by conventional firmware upgrade methods. Therefore firmware of different versions can be dynamically switched and executed on demand, eliminating dependency on memory 205. In the alternative mode, integrity checking is also performed to validate the integrity of the firmware file 202 in the memory card 201.

In another embodiment, the memory card 201 comprises a plurality of firmware files 202, each of different versions. When the DVD-ROM drive 203 enters the alternative mode, a decision making step is processed to choose and execute one firmware file 202 from the memory card 201. Otherwise when in upgrade mode, the decision making step is processed to choose which firmware file 202 to write into the memory 205. Additionally, when the DVD-ROM drive 203 is switched to a backup mode, firmware in memory 205 is copied to the memory card 201.

DVD-ROM drive 203 is controlled by firmware, thus after initializing the firmware manager 204, a firmware managing procedure is activated to obtain the required firmware, comprising steps of determining whether a memory card 201 is available, executing firmware in memory 205, and when the memory card 201 is not available, determining which firmware to execute when the memory card 201 is available and comprises at least one firmware file 202, and outputing the obtained firmware file to the central processing unit. The firmware management system in the firmware manager 204 can also be a program included in the firmware file 202. After initializing the DVD-ROM drive 203 through old firmware stored in memory 205, when the new firmware file 202 is loaded, in memory 205 or in memory card 201, the processor can then execute the new firmware file 202 by registering a pointer to the address where the new firmware file 202 resides.

By means of applying memory card 201 to firmware upgrade and execution, via firmware manager 204, the present invention provides the previously described advantages of portability, improved flexibility and reliability of firmware upgrade, and reduced resource and power consumption.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A firmware upgrade method, comprising the following steps:
providing a memory card comprising a first firmware file;
providing a device comprising memory for storing firmware; and
writing the first firmware file to the memory.

2. The method as claimed in claim 1, wherein the first firmware file comprises:
a version code, for checking version validity while upgrading;
a check sum code, for checking firmware file integrity; and
a length code, for checking firmware file length.

3. The method as claimed in claim 1, further comprising checking integrity of the first firmware file before writing the first firmware file to the memory.

4. The method as claimed in claim 1, further comprising copying a second firmware file from the memory to the memory card before writing the first firmware file to the memory.

5. The method as claimed in claim 1, further comprising:
checking integrity of the first firmware file in the memory after the first firmware file being written to the memory; and
writing status information to a log in the memory card.

6. The method as claimed in claim 1, further comprising:
copying a second firmware file from the memory to the memory card before the first firmware file being written to the memory;
checking integrity of the first firmware file in the memory after the first firmware file being written to the memory;
writing status information to a log in the memory card; and
when the log indicates an error, copying the second firmware file from the memory card to the memory.

7. A firmware equipped device, comprising:
a card reader, for reading a first firmware file from a memory card;
a memory, for storing the first firmware file; and
a firmware manager, for writing the first firmware file to the memory.

8. The device as claimed in claim 7, wherein the first firmware file comprises:
a version information, for checking version validity during upgrade;
a check sum code, for checking firmware file integrity; and
a length code, for checking firmware file length.

9. The device as claimed in claim 7, wherein:
the memory is a memory capable of preserving data when powered off;
the memory card is a portable storage device; and
the device is a compact disc recorder, a compact disc player, or a compact disc reader.

10. The device as claimed in claim 7, wherein the firmware manager checks integrity of the first firmware file before the first firmware file being written to the memory.

11. The device as claimed in claim 7, wherein the firmware manager backups a second firmware file from the memory to the memory card before the first firmware file being written to the memory.

12. The device as claimed in claim 7, wherein the firmware manager is capable of performing the following steps:
checking integrity of the first firmware file in the memory after the first firmware file being written to the memory, and
writing status information in a log in the memory card.

13. The device as claimed in claim 7, wherein the firmware manager is capable of performing the following steps:
backing up a second firmware file from the memory to the memory card before the first firmware file being written to the memory;
checking integrity of the first firmware file in the memory after the first firmware file being written to the memory;
writing a status information in a log in the memory card for future reference; and
when the log indicates an error, coping the second firmware file from the memory card to the memory.

14. A firmware upgrade method, comprising the following steps:
attaching a memory card to a device, wherein the memory card stores at least one firmware file; and
processing the firmware file in the memory card directly to control the device.

15. The method as claimed in claim 14, further comprising the following step:
when the memory card comprises a plurality of firmware files with different versions, only one firmware file is chosen to control the device.

16. The method as claimed in claim 14, further comprising the step of:
checking integrity of the firmware file in the memory card before processing the firmware file directly to control the device.

17. The method as claimed in claim 14, further comprising the step of:
copying the firmware file from the memory card to memory in the device.

18. A device capable of upgrading firmware, comprising:
a card reader, for reading at least one firmware file from a memory card; and
a firmware manager, for directly processing the firmware file in the memory card to control the apparatus.

19. The device as claimed in claim 18, further comprising a memory for storing the firmware file.

20. The device as claimed in claim 18, wherein the firmware manager is capable of performing at least one of the following:
when the memory card comprises a plurality of firmware files with different versions, choosing only one firmware file to control the device; and
checking integrity of the firmware in the memory card before processing the firmware file.
